(19) United States
(12) Patent Application Publication
(10) Pub. No.: US 2006/0026901 A1
(43) Pub. Date: Feb. 9, 2006

(54) Door drive head

(76) Inventor: Michael Hörmann, (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/189,378

(22) Filed: Jul. 26, 2005

(30) Foreign Application Priority Data
Jul. 26, 2004 (DE) 20 2004 011 665.0

(51) Int. Cl. E05D 15/10

(52) U.S. Cl. 49/212

(57) ABSTRACT

The invention relates to a door drive head comprising a preferably shell-shaped carrier base body to which different drive components can be attached and which has connection means at its outer side to which a carriage rail can be connected in which a door drive carriage runs which, on the one hand, is driven via a driving means by the drive motor supported in the housing and, on the other hand, moves the door to be driven. In accordance with the invention, the carriage rail can be inwardly pivoted into its mounting position around a pivot axle projecting outwardly out of the carrier base body.

The invention relates to a door drive head comprising a preferably shell-shaped carrier base body to which different drive components can be attached and which has connection means at its outer side to which a carriage rail can be connected in which a door drive carriage runs which, on the one hand, is driven via a driving means by the drive motor supported in the housing and, on the other hand, moves the door to be driven.

Door drives such as garage door drives are typically arranged in a housing which is attached in the case of a garage door drive to the ceiling inside the garage. As a rule, the drive motor and a transmission are arranged in the housing, the transmission driving a carriage via a chain or a belt, said carriage running on a carriage rail connected to the housing. The garage door is attached to the carriage so that it can be opened and closed. The door drive is accommodated in a so-called door drive head which comprises a carrier base body to which different drive components can be attached. This carrier base body is covered by a cover hood. Connection means are provided at the cover hood's lower side and the carriage rail can be mounted to them. The mounting of this carriage rail is complex in currently known embodiments since a number of mounting parts are required here. Tools are moreover necessary for the attachment of the mounting rail.

It is the object of the invention to provide a door drive head which permits a particularly simple and fast mounting of the mounting rail.

This object is solved in accordance with the invention by a door drive head in accordance with the combination of the features of claim 1. Preferred aspects of the invention are the subject of the dependent claims.

In accordance with the invention, a door drive head is therefore provided with a carrier base body, wherein the carriage rail can be inwardly pivoted into its mounting position around a pivot axle projecting outwardly from the carrier base body. The basic principle in accordance with the invention of the present invention therefore consists of the carriage rail being pivoted to the side of the door drive body while pushed onto a pivot axle and being inwardly pivoted thereabout into the mounting position. The mounting of the carriage rails is therefore possible here in a most simple manner with one manipulation. A series of additional mounting parts such as have to be provided in the prior art can be omitted in accordance with the invention.

It is particularly advantageous for the carriage rail to be able to be fixed in position by a snap mechanism after the inward pivoting into the mounting position.

The end of the carriage rail in the mounting position can be disposed between the outer side of the carrier base body and an oppositely disposed holding plate.

The snap mechanism can advantageously consist of resiliently supported lateral bounding portions of the carriage rail. In this connection, the resiliently supported lateral bounding portions are preferably each provided with a slanting run-on surface.

The pivot axle can advantageously be the driving axle for a drive element arranged in the carriage rail.

Further features, details and advantages of the invention will be explained in more detail with respect to an embodiment shown in the drawing. There are shown:

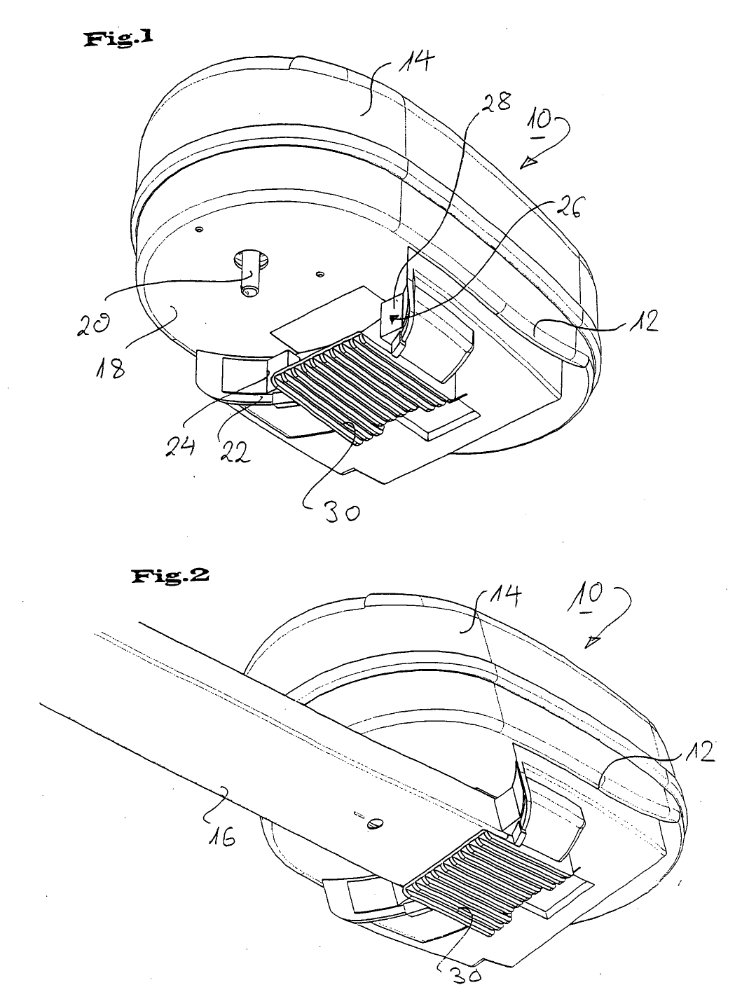

FIG. 1: a drive head in accordance with the present invention in a perspective representation;

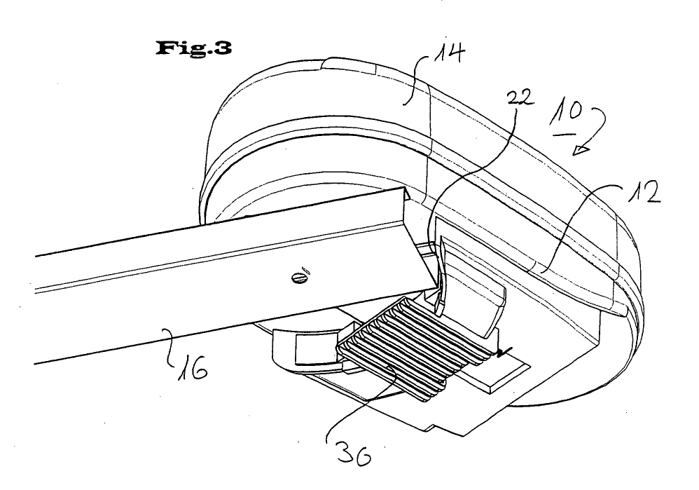

FIG. 2: the drive head of FIG. 1 with a mounted carriage rail; and

FIG. 3: a perspective representation of the drive head in accordance with FIGS. 1 and 2 in which the carriage rail is shown during its mounting.

The door drive head 10 comprises a door drive housing consisting of a carrier base body 12 and a cover hood 14 placed thereon. A drive motor, a transmission and an electronic control device are arranged inside the door drive housing 14 on the carrier base body 12 in a manner not shown in more detail here. The door drive housing of the door drive body 12 is connected to a carriage rail 16 (FIG. 2 and FIG. 3). A belt, or optionally a chain, driven by the drive motor extends in the carriage rail of C-shape in cross-section as a driving means to drive a door carriage supported in the carriage rail. The belt or the chain serving as a driving means is driven via a driving pinion in a manner not shown in any more detail here.

The driving axle 20, which projects out of the lower outer side 18 of the carrier base body 12 and serves as the pivot axle for the carriage rail 16 is shown schematically in FIG. 1. The carriage rail 16 includes a driving pinion not shown in FIGS. 1 to 3 and pushable there onto the driving axle 20. To permit a mounting of the carriage rail 16, an approximately circular pivot region is left free on the lower outer side of the carrier base body 12 in a pre-determined radius around the driving axle 20 serving as the pivot axle. The pivot region is bounded at one side by a peripheral wall 22 which is disposed in the outer pivot radius of the carriage rail 16 to be inwardly pivoted, as results in particular from FIG. 3.

Two resiliently supported lateral bounding portions 24 and 26 are provided in the region of the wall 22. These resiliently supported lateral bounding portions form a snap mechanism for the lateral fixing in position of the carriage rail, as is shown in FIG. 2. For the simpler inward pivoting of the resiliently supported bounding portions for the carriage rail, they have slanted run-up surfaces 28. On the inward pivoting of the carriage rail 16, as shown in FIG. 3, the side wall of the guide rail 16 runs onto the slanted run-up surface 28 so that the resiliently supported lateral bounding portion 26 is pressed on against the resilient force. The carriage rail can thereby be inwardly pivoted in the mounting position. On reaching the mounting position, as shown in FIG. 2, the resiliently mounted lateral bounding portion 26 pivots back into its starting position and thus fixes the carriage rail 16 laterally. In the region of the end of the carriage rail 16, the latter is engaged over by a holding plate 30 and is fixed in position, as shown in FIG. 2.

1. A door drive head comprising a preferably shell-shaped carrier base body to which different drive components can be attached and which has connection means at its outer side to which a carriage rail can be connected in which a door drive carriage runs which, on the one hand, is driven via a driving means by the drive motor supported in the housing and, on the other hand, moves the door to be driven,
characterized in that
the carriage rail is inwardly pivoted into its mounting position around a pivot axle projecting outwardly out of the carrier base body.

2. A door drive head in accordance with claim 1, wherein the carriage rail can be fixed in position by a snap mechanism after the inward pivoting into the mounting position.

3. A door drive head in accordance with claim 1, wherein the end of the carriage rail in the mounting position is disposed between the outside of the carrier base body and an oppositely disposed holding plate.

4. A door drive head in accordance with claim 2, wherein the snap mechanism consists of resiliently supported lateral bounding portions for the carriage rail.

5. A door drive head in accordance with claim 4, wherein the resiliently supported lateral bounding portions each have a slanted run-up surface.

6. A door drive head in accordance with claim 1, wherein the pivot axle is the driving axle for a drive element arranged in the carriage rail.
